(19) United States
(12) Patent Application Publication
(10) Pub. No.: US 2021/0189066 A1
(43) Pub. Date: Jun. 24, 2021

(54) POLYIMIDE PRECURSOR SOLUTION AND METHOD FOR PRODUCING POLYIMIDE FILM

(71) Applicant: FUJI XEROX CO., LTD., Tokyo (JP)

(72) Inventors: Kosaku YOSHIMURA, Kanagawa (JP); Yasunobu KASHIMA, Kanagawa (JP); Tomoya SASAKI, Kanagawa (JP); Kosuke NAKADA, Kanagawa (JP); Hidekazu HIROSE, Kanagawa (JP)

(73) Assignee: FUJI XEROX CO., LTD., Tokyo (JP)

(21) Appl. No.: 16/847,630

(22) Filed: Apr. 13, 2020

(30) Foreign Application Priority Data
Dec. 18, 2019 (JP) 2019-228327

(51) Int. Cl. C08G 73/10; C08J 5/18

(52) U.S. Cl. CPC C08G 73/1071; C08K 5/3445; C08G 73/1032; C08J 5/18

(57) ABSTRACT

A polyimide precursor solution includes a polyimide precursor; an imidazole compound; a tertiary amine compound other than the imidazole compound; and an aqueous solvent containing water, in which a ratio of the number of moles of the imidazole compound to the number of moles of a tetracarboxylic dianhydride component of the polyimide precursor is 0.5 or more and less than 1.6, a ratio of the number of moles of the tertiary amine compound to the number of moles of the imidazole compound is within a range of 0.3 to 6.0, and a content of the water is 50% by mass or more with respect to the aqueous solvent.

### CROSS-REFERENCE TO RELATED APPLICATIONS

This application is based on and claims priority under 35 USC 119 from Japanese Patent Application No. 2019-228327 filed Dec. 18, 2019.

### BACKGROUND

### (i) Technical Field

The present invention relates to a polyimide precursor solution and a method for producing a polyimide film.

### (ii) Related Art

A polyimide resin is a material having excellent characteristics of mechanical strength, chemical stability, and heat resistance, and a polyimide film having these characteristics have attracted attention.

For example, JP2012-140582A proposes a “method for producing a polyimide precursor aqueous solution composition, the method including reacting a tetracarboxylic dianhydride with a diamine having a solubility in water at 25° C. of 0.1 g/L or more in the presence of imidazoles using water as a reaction solvent to produce an aqueous solution composition of a polyimide precursor.”

For example, JP2012-036382A proposes a “polyimide precursor aqueous solution composition obtained as follows: a polyamic acid obtained by reacting a tetracarboxylic acid component and a diamine component is dissolved in an aqueous solvent together with imidazoles having two or more alkyl groups as substituents, in which an amount of the imidazoles is 1.6 times moles or more an amount of the tetracarboxylic acid component of the polyamic acid.

### SUMMARY

Aspects of non-limiting embodiments of the present disclosure relate to a polyimide precursor solution from which a high-strength dried film and polyimide film of a polyimide precursor, can be obtained as compared with a polyimide precursor solution including a polyimide precursor; an imidazole compound (A); a tertiary amine compound (B) other than the imidazole compound; and an aqueous solvent containing water, in which a content of the water with respect to the aqueous solvent is 50% by mass, and in which a ratio of the number of moles of the imidazole compound (A) to the number of moles of a tetracarboxylic dianhydride component of the polyimide precursor is less than 0.5 or 1.6 or more, or a ratio of the number of moles of the tertiary amine compound (B) to the number of moles of the imidazole compound (A) is less than 0.3 or more than 6.0.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a polyimide precursor solution includes a polyimide precursor; an imidazole compound (A); a tertiary amine compound (B) other than the imidazole compound; and an aqueous solvent containing water, in which a ratio of the number of moles of the imidazole compound (A) to the number of moles of a tetracarboxylic dianhydride component of the polyimide precursor is 0.5 or more and less than 1.6, a ratio of the number of moles of the tertiary amine compound (B) to the number of moles of the imidazole compound (A) is 0.3 to 6.0, and a content of the water is 50% by mass or more with respect to the aqueous solvent.

### DETAILED DESCRIPTION

Hereinafter, an exemplary embodiment of the present invention will be described in detail with reference to the accompanying drawings. Descriptions and examples illustrate the exemplary embodiment and do not limit the scope of the exemplary embodiment.

In numerical value ranges described stepwise in this specification, the upper limit or the lower limit described in one numerical value range may be replaced with the upper limit or the lower limit of another numerical value range described stepwise. In addition, in a numerical value range described in this specification, the upper limit value or the lower limit value of this numerical value range may be replaced with values shown in Examples.

In this specification, the term “step” is not limited to an independent step, and even steps that cannot be clearly distinguished from other steps are also included in this term as long as the intended purpose of the steps is achieved.

As respective components, a plurality of substances corresponding thereto may be contained.

In a case of referring to an amount of respective components in a composition, this refers to a total amount of a plurality of substances corresponding thereto present in the composition unless otherwise specified in a case where the plurality of substances corresponding to the respective components are present in the composition.

In this exemplary embodiment, the term “film” is a concept including not only a material generally called a “film” but also a material generally called a “film” and a “sheet”.

Polyimide Precursor Solution

A polyimide precursor solution according to this exemplary embodiment includes a polyimide precursor; an imidazole compound (A); a tertiary amine compound (B) other than the imidazole compound; and an aqueous solvent containing water.

A ratio of the number of moles of the imidazole compound (A) to the number of moles of a tetracarboxylic dianhydride component of the polyimide precursor is 0.5 or more and less than 1.6, a ratio of the number of moles of the tertiary amine compound (B) to the number of moles of the imidazole compound (A) is 0.3 to 6.0, and a content of the water is 50% by mass or more with respect to the aqueous solvent.

Since the polyimide precursor solution according to this exemplary embodiment has the above-mentioned configuration, it is possible to obtain a polyimide precursor solution that becomes a high-strength dried film and polyimide film of a polyimide precursor. The reason for this is not clear but is presumed as follows.

A polyimide film is produced by applying a polyimide precursor solution to a substrate to forma coating film, drying the coating film to form a dried film, peeling the dried film from the substrate, and thereafter baking the dried film (that is, imidization).

In a case where a polyimide film is produced in the above-mentioned step, strength of the dried film is required to be high in the step of peeling the dried film from the substrate.

An imidazole compound not only increases solubility of the polyimide precursor in water, but also has catalytic activity in a case where the polyimide precursor is imidized (dehydration and ring-closure) to become a polyimide. Accordingly, it is effective to add an imidazole compound to an aqueous polyimide precursor solution. However, in a case where a large amount of imidazole compound is added, an imidazole compound remaining in a dried film acts as a plasticizer, thereby decreasing strength of the dried film. As a result, a peeled dried film is unlikely to become a free-standing film in some cases. In addition, the dried film may be partially broken and remain on a substrate in a peeling step in some cases. Furthermore, strength of a polyimide film also decreases in some cases.

On the other hand, in a case where a small amount of imidazole compound is added, catalytic activity is reduced, and a polyimide precursor is not obtained or only a polyimide precursor of a low molecular weight is obtained in some cases.

The polyimide precursor solution according to this exemplary embodiment includes the imidazole compound (A) and the tertiary amine compound (B) other than the imidazole compound as compounds increasing solubility of the polyimide precursor in water and acting as catalysts in a case of forming a polyimide. In addition, a ratio of the number of moles of the imidazole compound (A) to the number of moles of the tetracarboxylic dianhydride component of the polyimide precursor is 0.5 or more and less than 1.6, a ratio of the number of moles of the tertiary amine compound (B) to the number of moles of the imidazole compound (A) is 0.3 to 6.0. As a result, an amount of the imidazole compound (A) added in the polyimide precursor solution is decreased, thereby increasing strength of a dried film and a polyimide film. In addition, reduced catalytic activity caused by the decrease in amount of the imidazole compound (A) can be compensated for by adding the tertiary amine compound (B) other than the imidazole compound, and thereby a polyimide precursor of a high molecular weight can be obtained.

Polyimide Precursor

The polyimide precursor solution of this exemplary embodiment includes the polyimide precursor.

Specifically, the polyimide precursor is a resin (a polyimide precursor) having a repeating unit represented by General Formula (I).

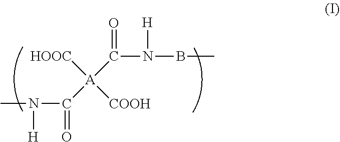

In General Formula (I), A represents a tetravalent organic group, and B represents a divalent organic group.

In General Formula (I), the tetravalent organic group represented by A is a residue obtained in a case where four carboxyl groups have been removed from a tetracarboxylic dianhydride as a raw material.

Meanwhile, the divalent organic group represented by B is a residue obtained in a case where two amino groups have been removed from a diamine compound as a raw material.

That is, the polyimide precursor having the repeating unit represented by General Formula (I) is a polymer of a tetracarboxylic dianhydride and a diamine compound.

Examples of tetracarboxylic dianhydrides include any compound of aromatic and aliphatic compounds, but, for example, an aromatic compound is preferable. That is, in General Formula (I), the tetravalent organic group represented by A is, for example, preferably an aromatic organic group.

Examples of aromatic tetracarboxylic dianhydrides include pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furan tetracarboxylic dianhydride, 4,4′-bis (3,4-dicarboxyphenoxy) diphenyl sulfide dianhydride, 4,4′-bis (3,4-dicarboxyphenoxy) diphenyl sulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic acid)phenyl phosphine oxide dianhydride, p-phenylene-bis(triphenylphthalic acid) dianhydride, m-phenylene-bis(triphenylphthalic acid) dianhydride, bis (triphenylphthalic acid)-4,4′-diphenyl ether dianhydride, bis(triphenylphthalic acid)-4,4′-diphenylmethane dianhydride, and the like.

Examples of aliphatic tetracarboxylic dianhydrides include aliphatic or alicyclic tetracarboxylic dianhydride such as butane tetracarboxylic dianhydride, 1,2,3,4-cyclobutane tetracarboxylic dianhydride, 1,3-dimethyl-1,2,3,4-cyclobutane tetracarboxylic dianhydride, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-di carboxylic dianhydride, and bicyclo[2,2,2]-oct-7-ene-2,3,5,6-tetracarboxylic dianhydride; an aliphatic tetracarboxylic dianhydride having an aromatic ring such as 1,3,3a,4,5,9b-hexahydro-(2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione; and the like.

Among the above examples, as tetracarboxylic dianhydrides, for example, the aromatic tetracarboxylic dianhydride is preferable, and specifically, for example, pyromellitic dianhydride, 3,3′,4,4′-biphenyl tetracarboxylic dianhydride, 2,3,3′,4′-biphenyl tetracarboxylic dianhydride, 3,3′,4,4′-biphenyl ether tetracarboxylic dianhydride, and 3,3′,4,4′-benzophenone tetracarboxylic dianhydride are preferable, pyromellitic dianhydride, 3,3′,4,4′-biphenyl tetracarboxylic dianhydride, and 3,3′,4,4′-benzophenone tetracarboxylic dianhydride are more preferable, and 3,3′,4,4′-biphenyl tetracarboxylic dianhydride is particularly preferable.

A tetracarboxylic dianhydride may be used alone or in combination of two or more kinds thereof.

In addition, in a case of the combination use of two or more kinds thereof, each of an aromatic tetracarboxylic dianhydride or an aliphatic tetracarboxylic acid may be used in combination, or an aromatic tetracarboxylic dianhydride and an aliphatic tetracarboxylic dianhydride may be combined to be used.

Meanwhile, a diamine compound is a diamine compound having two amino groups in a molecule structure. Examples of diamine compounds include any compound of aromatic and aliphatic compounds, and for example, an aromatic compound is preferable. That is, in General Formula (I), the divalent organic group represented by B is, for example, preferably an aromatic organic group.

Examples of diamine compounds include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl] propane, 2,2-bis[4-(4-aminophenoxy)phenyl] hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl] hexafluoropropane, and 4,4′-bis[4-(4-amino-2-trifluoromethyl)phenoxy]-octafluorob iphenyl; an aromatic diamine having two amino groups bonded to an aromatic ring such as diaminotetraphenylthiophene and a hetero atom other than the nitrogen atom of the amino group; aliphatic diamines and alicyclic diamines such as 1,1-meta-xylylene diamine, 1,3-propane diamine, tetramethylene diamine, pentamethylene diamine, octamethylene diamine, nonamethylene diamine, 4,4-diaminoheptamethylene diamine, 1,4-diaminocyclohexane, isophorone diamine, tetrahydrodicyclopentadienylenediamine, hexahydro-4,7-methanoindanylenedimethylene diamine, tricyclo[6,2,1,0^{2.7}]-undecylenedimethyldiamine, and 4,4′-methylenebis(cyclohexylamine); and the like.

Among the above examples, as diamine compounds, for example, the aromatic diamine compound is preferable, and specifically, for example, p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenyl sulfone are preferable, and 4,4′-diaminodiphenyl ether and p-phenylenediamine is particularly preferable.

A diamine compound may be used alone or in combination of two or more kinds thereof. In addition, in a case of the combination use of two or more kinds thereof, each of an aromatic diamine compound and an aliphatic diamine compound may be used in combination, or an aromatic diamine compound and an aliphatic diamine compound may be combined to be used.

A weight-average molecular weight of the polyimide precursor used in this exemplary embodiment is, for example, preferably 5000 to 300000, and more preferably 10000 to 150000.

A weight-average molecular weight of the polyimide precursor is measured by a gel permeation chromatography (GPC) method under following measurement conditions.
Column: TSKgel α-M of TOSOH CORPORATION (7.8 mm I.D×30 cm)
Eluent: DMF (dimethylformamide)/30 mM LiBr/60 mM phosphoric acid
Flow rate: 0.6 mL/min
Injection volume: 60 μL
Detector: RI (differential refractive index detector)

A content of the polyimide precursor contained in the polyimide precursor solution according to this exemplary embodiment is, for example, preferably 0.1% by mass to 40% by mass, and more preferably 1% by mass to 25% by mass with respect to a total mass of the polyimide precursor solution.

Aqueous Solvent

The polyimide precursor solution according to this exemplary embodiment includes the imidazole compound (A), the tertiary amine compound (B) other than the imidazole compound, and the aqueous solvent containing water.

Imidazole Compound (A)

The polyimide precursor solution of this exemplary embodiment includes the imidazole compound (A).

The imidazole compound (A) refers to an amine compound having an imidazole skeleton.

The imidazole compound (A) increases solubility of the polyimide precursor in water, and has catalytic activity in a case where the polyimide precursor is imidized (dehydration and ring-closure) to become a polyimide.

As the imidazole compound (A), for example, a compound represented by Formula (0) is preferable. However, in Formula (0), R¹¹, R¹², R¹³, and R¹⁴ each independently represent a hydrogen atom or an alkyl group.

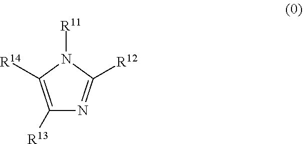

In the imidazole compound (A) represented by Formula (0), an alkyl group represented by R¹¹, R¹², R¹³, and R¹⁴ is, for example, preferably a linear or branched alkyl group having 1 to 5 carbon atoms (specifically, for example, a methyl group, an ethyl group, a propyl group, a butyl group, a pentyl group, and the like).

The imidazole compound (A) is, for example, preferably an imidazole compound substituted by two or more alkyl groups. That is, in Formula (0), the imidazole compound (A) is, for example, preferably an imidazole compound in which two or more of R¹¹, R¹², R¹³, and R¹⁴ represent an alkyl group.

Specific examples of the imidazole compound (A) include 1,2-dimethylimidazole, 2-ethyl-4-methylimidazole, 4-ethyl-2-methylimidazole, 1-methyl-4-ethylimidazole, and the like.

The imidazole compound (A) may be used alone or in combination of two or more kinds thereof.

From the viewpoint of obtaining a high-strength dried film and polyimide film of the polyimide precursor, a ratio of the number of moles of the imidazole compound (A) to the number of moles of the tetracarboxylic dianhydride component of the polyimide precursor is 0.5 or more and less than 1.6.

From the viewpoint of obtaining a high-strength dried film and polyimide film of the polyimide precursor, a ratio of the number of moles of the imidazole compound (A) to the number of moles of the tetracarboxylic dianhydride component of the polyimide precursor is, for example, preferably 0.5 to 1.5, and more preferably 0.8 to 1.5.

The number of moles of the tetracarboxylic dianhydride component of the polyimide precursor is the number of moles of tetracarboxylic dianhydride when producing the polyimide precursor.

In addition, the number of moles of the imidazole compound (A) is the number of moles of the imidazole compound (A) contained in the polyimide precursor solution.

Tertiary Amine Compound (B)

The polyimide precursor solution of this exemplary embodiment includes the tertiary amine compound (B) other than the imidazole compound.

The tertiary amine compound (B) increases solubility of the polyimide precursor in water, and has catalytic activity in a case where the polyimide precursor is imidized (dehydration and ring-closure) to become a polyimide. In addition, by combination use with the imidazole compound (A) in the polyimide precursor solution in combination, a content of the imidazole compound (A) can be reduced, and thereby a high-strength dried film and polyimide film of the polyimide precursor can be obtained.

Examples of the tertiary amine compound (B) include an acyclic amine compound and a cyclic amine compound.

Examples of acyclic amine compounds include a trialkylamine (a tertiary amine compound having an alkyl group), a tertiary amino alcohol (a tertiary amine compound having an alkyl chain and a hydroxy group), and the like.

Examples of cyclic amine compounds include N-substituted piperazines (amine compounds having a piperazine skeleton), N-substituted morpholines (amine compounds having a morpholine skeleton), isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), triazines (amine compounds having a triazine skeleton), polypyridine, and the like.

The carbon number of acyclic amine compound is not particularly limited, but is, for example, preferably 3 to 18, more preferably 3 to 15, and even more preferably 3 to 12.

The carbon number of cyclic amine compound is not particularly limited, but is, for example, preferably 3 to 10, more preferably 3 to 9, and even more preferably 3 to 8.

From the viewpoint of obtaining a high-strength dried film and polyimide film of the polyimide precursor, for example, at least one compound selected from the group consisting of N-substituted morpholine, trialkylamine, and tertiary amino alcohol is preferable.

As a substituent of N-substituted morpholine, for example, an alkyl group is preferable.

The carbon number of an alkyl group is, for example, preferably 1 to 6, more preferably 1 to 5, and even more preferably 1 to 4.

Specific examples of N-substituted morpholines include N-methylmorpholine, N-ethylmorpholine, N-propylmorpholine, N-butylmorpholine, and the like.

The carbon number of an alkyl group included in trialkylamine is, for example, preferably 1 to 6, more preferably 1 to 5, and even more preferably 1 to 4.

Specific examples of trialkylamines include triethylamine, trimethylamine, N,N-dimethylethylamine, N,N-dimethylpropylamine, N,N-dimethylbutylamine, N,N-diethylmethylamine, N,N-dipropylethylamine, N,N-dimethylisopropylamine, and the like.

The carbon number of alcohol included in the tertiary amino alcohol is, for example, preferably 1 to 6, more preferably 1 to 5, and even more preferably 1 to 4.

In a case where a tertiary amino alcohol has an alkyl group, the carbon number of an alkyl group is, for example, preferably 1 to 6, more preferably 1 to 5, and even more preferably 1 to 4.

Examples of tertiary amino alcohols include N,N-dimethylethanolamine, N,N-dimethylpropanolamine, N,N-dimethylisopropanolamine, N,N-diethylethanolamine, N-ethyldiethanolamine, N-methyldiethanolamine, triethanolamine, triisopropanolamine, and the like.

The tertiary amine compound (B) is, for example, more preferably N-substituted morpholine from the viewpoint of obtaining a high-strength dried film and polyimide film of the polyimide precursor.

The tertiary amine compound (B) may be used alone or in combination of two or more thereof.

From the viewpoint of obtaining a high-strength dried film and polyimide film of the polyimide precursor, a ratio of the number of moles of the tertiary amine compound (B) to the number of moles of the imidazole compound (A) is, for example, 0.3 to 6.0, is preferably 0.5 to 3.0, and is more preferably 0.5 to 2.0.

From the viewpoint of obtaining a high-strength dried film and polyimide film of the polyimide precursor, a ratio of the number of moles of the tertiary amine compound (B) to the number of moles of the tetracarboxylic dianhydride component of the polyimide precursor is, for example, preferably 0.5 to 3.0, more preferably 0.6 to 2.5, and even more preferably 0.7 to 2.0.

A total content of the imidazole compound (A) and the tertiary amine compound (B) contained in the polyimide precursor solution according to this exemplary embodiment (a mass of the imidazole compound (A)+a mass of the tertiary amine compound (B)) is, for example, preferably 1% by mass to 50% by mass, more preferably 2% by mass to 30% by mass, and even more preferably 3% by mass to 20% by mass with respect to a total mass of the aqueous solvent contained in the polyimide precursor solution.

The number of moles of the imidazole compound (A) is the number of moles of the imidazole compound (A) contained in the polyimide precursor solution.

In addition, the number of moles of the tertiary amine compound (B) is the number of moles of the tertiary amine compound (B) contained in the polyimide precursor solution.

The number of moles of the tetracarboxylic dianhydride component of the polyimide precursor is the number of moles of tetracarboxylic dianhydride when producing the polyimide precursor.

A boiling point of the tertiary amine compound (B) is, for example, preferably lower than a boiling point of the imidazole compound (A).

The reason is as follows.

In a case where the tertiary amine compound (B) remains in a polyimide film, strength of the polyimide film decreases. Accordingly, as the tertiary amine compound (B), for example, it is preferable to use a compound that is more volatile than the imidazole compound (A) when baking a dried film.

Specifically, a difference in boiling points between the imidazole compound (A) and the tertiary amine compound (B) (a boiling point of the imidazole compound (A)−a boiling point of the tertiary amine compound (B)) is, for example, preferably 30° C. to 150° C.

A boiling point of the tertiary amine compound (B) is, for example, preferably 150° C. or lower, more preferably 140° C. or lower, and even more preferably 135° C. or lower.

A boiling point of the tertiary amine compound (B) is, for example, preferably 60° C. or higher, more preferably 70° C. or higher, and even more preferably 80° C. or higher.

Water

The aqueous solvent used in this exemplary embodiment contains water.

Examples of water include distilled water, ion exchange water, ultrafiltered water, pure water, and the like.

A content ratio of water used in this exemplary embodiment is, for example, preferably 50% by mass to 99% by mass, more preferably 70% by mass to 97% by mass, and even more preferably 80% by mass to 96% by mass with respect to a total mass of the aqueous solvent contained in the polyimide precursor solution.

A content of the aqueous solvent contained in the polyimide precursor solution according to this exemplary embodiment is, for example, preferably 60% by mass to 99.9% by mass, and more preferably 75% by mass to 99% by mass with respect to a total mass of the polyimide precursor solution.

Other Components

The polyimide precursor solution may include other water-soluble organic solvents in addition to the polyimide precursor, the imidazole compound (A), the tertiary amine compound (B), and water.

A content ratio of the other water-soluble organic solvents is, for example, preferably 10% by mass or less, 5% by mass or less, or 1% by mass or less with respect to a total mass of the aqueous solvent contained in the polyimide precursor solution.

The term “water-soluble” indicates that a target substance is dissolved by 1% by mass or more with respect to water at 25° C.

Examples of other water-soluble organic solvents include aprotic polar solvents, water-soluble ether solvents, water-soluble ketone solvents, and water-soluble alcohol solvents.

The polyimide precursor solution according to this exemplary embodiment may include a catalyst for accelerating an imidization reaction, a leveling agent for improving quality of a film to be formed, and the like.

As the catalyst for accelerating an imidization reaction, a dehydrating agent such as an acid anhydride, an acid catalyst such as a phenol derivative, a sulfonic acid derivative, and a benzoic acid derivative, or the like may be used.

In addition, the polyimide precursor solution may include, for example, particles according to the intended use of the polyimide film.

Examples of particles include resin particles, inorganic particles, and the like.

A material of the particles is not particularly limited as long as the particles are not dissolved but dispersed in the polyimide precursor solution. In this exemplary embodiment, the particles may be kept contained in a polyimide film to be produced using the polyimide precursor solution, or the particles may be removed from a polyimide film to be produced to obtain a porous polyimide film.

A volume average particle diameter D50v of the particles is not particularly limited. The volume average particle diameter D50v of the particles may be, for example, 0.05 μm to 10 μm.

A volume average particle size distribution index (GSDv) of the particles is, for example, preferably 1.30 or less.

A volume average particle size distribution index of the particles is calculated as (D84v/D16v)^{1/2} from a particle size distribution of the particles contained in the polyimide precursor solution.

A particle size distribution of the particles in the polyimide precursor solution is measured as follows. A solution that is a measurement target is diluted, and a particle size distribution of particles in the solution is measured using COULTER COUNTER LS13 (manufactured by Beckman Coulter, Inc.). Based on the measured particle size distribution, a particle size distribution with respect to a divided particle size range (channel) is measured by drawing a volume cumulative distribution from a smaller diameter side.

Then, from the volume cumulative distribution drawn from the smaller diameter side, a particle diameter at which a cumulative amount becomes 16% is defined as a volume particle diameter D16v, a particle diameter at which a cumulative amount becomes 50% is defined as a volume average particle diameter D50v, and a particle size at which a cumulative amount becomes 84% is defined as a volume particle diameter D84v.

Characteristics of Polyimide Film

Average Film Thickness

An average film thickness of the polyimide film to be produced using the polyimide precursor solution according to this exemplary embodiment is not particularly limited, and may be selected depending on use applications. An average film thickness may be, for example, 10 μm to 1000 μm. An average film thickness may be 20 μm or more, may be 30 μm or more, may be 500 μm or less, or may be 400 μm or less.

An average film thickness of a polyimide film in this exemplary

embodiment is obtained by cutting the obtained polyimide film along a film thickness direction, observing a cut surface at ten places with a scanning electron microscope (SEM), measuring a film thickness at each observation point from ten SEM images, and averaging the obtained ten measured values (film thickness).

Method for Producing Polyimide Film

A method for producing a polyimide film according to this exemplary embodiment includes Step (P-1) of applying the polyimide precursor solution to a substrate to form a coating film; Step (P-2) of drying the coating film to form a dried film; Step (P-3) of peeling the dried film from the substrate; and Step (P-4) of baking the dried film and imidizing the polyimide precursor contained in the dried film to form a polyimide film.

A polyimide contained in the polyimide film is specifically obtained by polymerizing a tetracarboxylic dianhydride and a diamine compound to generate a polyimide precursor, obtaining a polyimide precursor solution, and performing an imidization reaction.

Hereinafter, the method for producing a polyimide film according to this exemplary embodiment will be specifically described, but is not limited to this example.

Method for Producing Polyimide Precursor Solution

A method for producing a polyimide precursor solution according to this exemplary embodiment is not particularly limited, and examples thereof include the following production methods.

As an example, a method is exemplified in which a tetracarboxylic dianhydride and a diamine compound are polymerized in an aqueous solvent containing the imidazole compound (A), the tertiary amine compound (B), and water to produce a polyimide precursor, thereby obtaining a polyimide precursor solution.

According to this method, since the aqueous solvent is applied, productivity is high, and the polyimide precursor solution is produced in one step, which is, for example, preferable from the viewpoint of simplifying the steps.

As another example, a method is exemplified in which a tetracarboxylic dianhydride and a diamine compound are polymerized in an organic solvent such as an aprotic polar solvent (for example, N-methyl-2-pyrrolidone (NMP) and the like) to generate a polyimide precursor, and thereafter, the polyimide precursor is precipitated by adding an aqueous solvent such as water and alcohol, and thereafter, the precipitated polyimide precursor is dissolved in an aqueous solvent containing the imidazole compound (A), the tertiary amine compound (B), and water, thereby obtaining a polyimide precursor solution.

Hereinafter, the method for producing a polyimide film according to this exemplary embodiment will be described.

The method for producing a polyimide film according to this exemplary embodiment includes Step (P-1) that is a first step, Step (P-2) that is a second step, Step (P-3) that is a third step, and Step (P-4) that is a fourth step which are exemplified below.

Hereinafter, the first step is referred to as Step (P-1), the second step is referred to as Step (P-2), the third step is referred to as Step (P-3), and the fourth step is referred to as Step (P-4).

Step (P-1)

Step (P-1) is a step of applying the polyimide precursor solution to a substrate to form a coating film.

In the first step, the polyimide precursor solution according to this exemplary embodiment is prepared.

Next, the polyimide precursor solution is applied to the substrate to form a coating film.

The substrate on which the coating film containing the polyimide precursor and the particles is formed is not particularly limited. Examples thereof include a resin substrate made of polystyrene, polyethylene terephthalate, or the like; a glass substrate; a ceramic substrate; a metal substrate such as iron and stainless steel (SUS); a composite substrate that is a combination of these substrates; and the like. In addition, as necessary, the substrate may have a peeling layer by subjecting the substrate to a peeling process using, for example, a silicone-based or fluorine-based peeling agent, or the like.

A method for applying the polyimide precursor solution to the substrate is not particularly limited. Examples thereof include various methods such as a spray coating method, a spin coating method, a roll coating method, a bar coating method, a slit die coating method, and an ink jet coating method.

Step (P-2)

Step (P-2) is a step of drying the coating film that has been obtained in Step (P-1) to form a dried film.

Specifically, the coating film that has been obtained in Step (P-1) is dried by, for example, a method such as heat drying, natural drying, or vacuum drying to form a dried film. More specifically, the coating film is dried such that a content of the solvent remaining in the dried film becomes 50% or less (for example, preferably 30% or less) with respect to a solid content of the dried film, thereby forming a dried film.

Step (P-3)

Step (P-3) is a step of peeling the dried film that has been obtained in Step (P-2) from the substrate.

A method of peeling the dried film is not particularly limited, and examples thereof include a method in which a dried film is wound up by a winder including a drive shaft such as a torque motor and installed on a lower side or an upper side of the dried film, and the dried film is peeled from the substrate; and the like.

In the above description, the case in which the dried film is wound into a roll shape has been described, but the present invention is not limited thereto. Instead of winding the dried film into a roll shape, for example, the dried film may be cut at predetermined lengths after peeling.

Step (P-4)

Step (P-4) is a step of baking the dried film that has been peeled from the substrate in Step (P-3), and imidizing the polyimide precursor contained in the dried film to form a polyimide film.

A heating method for baking the dried film that has been peeled from the substrate in Step (P-3) to promote imidization, and thereby obtaining a polyimide film is not particularly limited. Examples thereof include a method in which heating is performed in multiple stages of two or more stages. For example, the following heating conditions are exemplified.

As heating conditions in a first stage, a temperature is, for example, preferably within a range of 50° C. to 150° C., and is more preferably within a range of 60° C. to 140° C. In addition, a heating time is not limited and may be within a range of 10 minutes to 60 minutes. A heating time may become shorter as a heating temperature becomes higher.

As heating conditions in a second stage and a subsequent stage, for example, heating is performed under conditions of 150° C. to and 450° C. (for example, preferably 200° C. to 400° C.) for 20 minutes to 120 minutes. By setting the heating conditions within the range, an imidization reaction further proceeds, and thereby a polyimide film is formed. In a heating reaction, for example, heating may be performed by raising a temperature step by step, or gradually raising a temperature at a certain speed before the temperature reaches a final temperature for the heating.

The heating conditions are not limited to the above-described heating method having two or more stages, and for example, a method of heating in one stage may be adopted. In the case of the method of heating in one stage, for example, imidization may be completed only under the above-mentioned heating conditions in the second stage and the subsequent stage.

As described above, the method for producing a polyimide film according to this exemplary embodiment has been described, but the method for producing a polyimide film according to this exemplary embodiment is not limited thereto.

For example, a porous polyimide film may be obtained by removing particles during Step (P-4) or after Step (P-4) in a state where the particles are contained in the polyimide precursor solution.

### EXAMPLES

Examples will be described below, but the present invention is not limited to these examples. In the following description, “parts” and “%” are all based on mass unless otherwise specified.

### Example 1

Production of Polyimide Precursor Solution (1)

780 parts of ion exchange water are heated to 50° C. under a nitrogen stream, and 18.81 parts of p-phenylenediamine (hereinafter referred to as “PDA”) and 51.19 parts of 3,3′,4,4′-biphenyltetracarboxylic dianhydride (hereinafter referred to as “BPDA”) are added while stirring. A mixture of 25.09 parts of dimethylimidazole (hereinafter referred to as “DMZ”) as the imidazole compound (A) (a ratio to the number of moles of BPDA: 1.5), 26.40 parts of N-methylmorpholine (hereinafter referred to as “MMO”) as the tertiary amine compound (B) (a ratio to the number of moles of DMZ: 1.0), and 98.52 parts of ion exchange water are added over 120 minutes at 50° C. under a nitrogen stream while stirring. The mixture is reacted at 50° C. for 15 hours, and thereby a polyimide precursor solution (1) having a concentration of solid contents of 7% is obtained.

### Examples 2 to 11 and Comparative Examples 1 to 6

Polyimide precursor solutions (2) to (11) and (Cl) to (C6) each having a concentration of solid contents of 7% are obtained in the same manner as in Example 1 except that the type and an amount of the imidazole compound (A) and the type and an amount of the tertiary amine compound (B) are changed as shown in Table 1.

Evaluation

Evaluation of Peelability of Dried Film

The polyimide precursor solutions obtained in Examples 1 to 11 and Comparative Examples 1 to 6 are applied to a glass substrate having a thickness of 1.0 mm in an area of 10 cm×10 cm using an applicator, and are dried in an oven at 80° C. for 30 minutes, and thereby a dried film having an average thickness of 30 μm is obtained.

After the obtained dried film is allowed to air-cool to room temperature, an end part of the dried film is floated using a razor, and in this state, the entire dried film is slowly peeled from the glass substrate, and peelability of the dried film is evaluated according to the following evaluation standard.

Evaluation Standard

A: The entire dried film is peelable without being broken.

B: After peeling ⅓ or more, the dried film is broken due to cracking or tear.

C: Before peeling ⅓ or more, the dried film is broken due to cracking or tear.

Evaluation of Strength of Polyimide Film

The dried film peeled from the glass substrate in the above-described evaluation of peelability of dried film is heated in an oven at 110° C., 180° C., 220° C., 250° C., 300° C., and 400° C. for 30 minutes respectively, and thereby a polyimide film is obtained.

Breaking strength of the obtained polyimide film is measured by a tensile tester (STROGRAPH VI-C, manufactured by Toyo Seiki Seisaku-sho, Ltd.), and peelability of a dried film is evaluated according to the following evaluation standard.

Evaluation Standard

A: Tensile strength of 200 MPa or more

B: Tensile strength of 50 MPa or more and less than 200 MPa

C: Tensile strength less than 50 MPa

Abbreviated compound names described in the column of the type of tetracarboxylic dianhydride component, the type of diamine compound, the type of imidazole compound (A), and the type of tertiary amine compound (B) in Table 1 are as follows.
BPDA: 3,3′,4,4′-Biphenyltetracarboxylic dianhydride
PDA: p-Phenylenediamine
DMZ: 1,3-Dimethylimidazole
MMO: N-Methylmorpholine
TEA: Triethylamine
DMAE: N,N-Dimethylethanolamine
Py: Pyridine
MDEA: N-Methyl-diethanolamine
DMEA: N,N-Dimethylethylamine
DMAP: 4-Dimethylaminopyridine

The symbol “-” described in Table 1 indicates that the tertiary amine compound (B) is not added.

In addition, the term “Inevaluable” described in Table 1 indicates that a polyimide precursor or polyimide film cannot be obtained, or that tensile strength cannot be measured because a polyimide film is broken before measurement by a tensile tester.

The term “Parts” of the imidazole compound (A) described in Table 1 refers to parts by mass of the imidazole compound (A) contained in the polyimide precursor solution.

The term “Number of moles” of the imidazole compound (A) described in Table 1 is the number of moles when parts by mass of the imidazole compound (A) contained in the polyimide precursor solution is represented by g.

The term “Ratio of the number of moles (to acid dianhydride)” of the imidazole compound (A) described in Table 1 is a ratio of the number of moles of the imidazole compound (A) to the number of moles of the tetracarboxylic dianhydride component.

The term “Parts” of the tertiary amine compound (B) described in Table 1 refers to parts by mass of the tertiary amine compound (B) contained in the polyimide precursor solution.

The term “Number of moles” of the tertiary amine compound (B) described in Table 1 is the number of moles when parts by mass of the tertiary amine compound (B) contained in the polyimide precursor solution is represented by g.

The term “Ratio of the number of moles (to acid dianhydride)” of the tertiary amine compound (B) described in Table 1 is a ratio of the number of moles of the tertiary amine compound (B) to the number of moles of the tetracarboxylic dianhydride component.

The term “Ratio of the number of moles (B)/(A)” of the tertiary amine compound (B) described in Table 1 is a ratio of the number of moles of the tertiary amine compound (B) to the number of moles of the imidazole compound (A).

The term “Content” of water described in Table 1 is % by mass with respect to a total mass of the aqueous solvent.

TABLE 1

| | | Imidazole compound (A) | | | | | | | | | |
|---|---|---|---|---|---|---|---|---|---|---|---|
| | | | | | | Ratio of the | | | | | |
| | Polyimide | | | | | number of moles | | Tertiary amine compound (B) | | | |
| | precursor | | | Number of | | (to acid | Boiling | | | Number of | |
| | solution | Type | Parts | moles | | dianhydride) | point | Type | Parts | moles | |
| Example 1 | (1) | DMZ | 25.09 | 261 | mmol | 1.5 | 204° C. | MMO | 26.40 | 261 | mmol |
| Example 2 | (2) | DMZ | 16.73 | 174 | mmol | 1.0 | 204° C. | MMO | 35.20 | 348 | mmol |
| Example 3 | (3) | DMZ | 10.04 | 104 | mmol | 0.6 | 204° C. | MMO | 59.84 | 592 | mmol |
| Example 4 | (4) | DMZ | 25.09 | 261 | mmol | 1.5 | 204° C. | MMO | 17.60 | 174 | mmol |
| Example 5 | (5) | DMZ | 25.09 | 261 | mmol | 1.5 | 204° C. | MMO | 8.80 | 87 | mmol |
| Example 6 | (6) | DMZ | 25.09 | 261 | mmol | 1.5 | 204° C. | TEA | 26.41 | 261 | mmol |
| Example 7 | (7) | DMZ | 25.09 | 261 | mmol | 1.5 | 204° C. | DMAE | 23.27 | 261 | mmol |
| Example 8 | (8) | DMZ | 25.09 | 261 | mmol | 1.5 | 204° C. | Py | 20.64 | 261 | mmol |
| Example 9 | (9) | DMZ | 25.09 | 261 | mmol | 1.5 | 204° C. | MDEA | 31.10 | 261 | mmol |
| Example 10 | (10) | DMZ | 25.09 | 261 | mmol | 1.5 | 204° C. | DMEA | 19.09 | 261 | mmol |
| Example 11 | (11) | DMZ | 25.09 | 261 | mmol | 1.5 | 204° C. | DMAP | 31.88 | 261 | mmol |
| Comparative | (C1) | DMZ | 40.14 | 418 | mmol | 2.4 | 204° C. | — | 0.00 | 0 | mmol |
| Example 1 | | | | | | | | | | | |
| Comparative | (C2) | DMZ | 33.45 | 348 | mmol | 2.0 | 204° C. | MMO | 17.60 | 174 | mmol |
| Example 2 | | | | | | | | | | | |
| Comparative | (C3) | DMZ | 8.36 | 87 | mmol | 0.5 | 204° C. | MMO | 61.60 | 609 | mmol |
| Example 3 | | | | | | | | | | | |
| Comparative | (C4) | DMZ | 25.09 | 261 | mmol | 1.5 | 204° C. | — | 0.00 | 0 | mmol |
| Example 4 | | | | | | | | | | | |
| Comparative | (C5) | DMZ | 7.53 | 78 | mmol | 0.5 | 204° C. | MMO | 44.87 | 444 | mmol |
| Example 5 | | | | | | | | | | | |
| Comparative | (C6) | DMZ | 26.09 | 271 | mmol | 1.6 | 204° C. | MMO | 7.74 | 77 | mmol |
| Example 6 | | | | | | | | | | | |

| | Tertiary amine compound (B) | | | | | | |
|---|---|---|---|---|---|---|---|
| | Ratio of the | Ratio of the | | | | | |
| | number of moles | number of | | | | Evaluation result of | Evaluation result of |
| | (to acid | moles | Boiling | | Water | peelability of dried | strength of polyimide |
| | dianhydride) | (B)/(A) | point | | Content | film | film |
| Example 1 | 1.5 | 1.00 | 116° | C. | 94.5% | A | A |
| Example 2 | 2.0 | 2.00 | 116° | C. | 94.4% | A | A |
| Example 3 | 3.4 | 5.67 | 116° | C. | 92.6% | A | B |
| Example 4 | 1.0 | 0.67 | 116° | C. | 95.4% | A | A |
| Example 5 | 0.5 | 0.33 | 116° | C. | 96.3% | B | A |
| Example 6 | 1.5 | 1.00 | 89° | C. | 94.5% | A | A |
| Example 7 | 1.5 | 1.00 | 133° | C. | 94.8% | A | A |
| Example 8 | 1.5 | 1.00 | 115° | C. | 95.1% | B | B |
| Example 9 | 1.5 | 1.00 | 247° | C. | 94.0% | B | B |
| Example 10 | 1.5 | 1.00 | 37° | C. | 95.3% | B | B |
| Example 11 | 1.5 | 1.00 | 162° | C. | 93.9% | B | B |
| Comparative | 0.0 | 0.00 | — | | 95.6% | C | Inevaluable |
| Example 1 | | | | | | | |
| Comparative | 0.5 | 0.50 | 116° | C. | 94.5% | C | Inevaluable |
| Example 2 | | | | | | | |
| Comparative | 3.5 | 7.00 | 116° | C. | 92.6% | C | Inevaluable |
| Example 3 | | | | | | | |
| Comparative | 0.0 | 0.00 | — | | 97.2% | Inevaluable | Inevaluable |
| Example 4 | | | | | | | |
| Comparative | 2.6 | 5.67 | 116° | C. | 94.4% | B | C |
| Example 5 | | | | | | | |
| Comparative | 0.4 | 0.28 | 116° | C. | 96.4% | B | C |
| Example 6 | | | | | | | |

Based on the results shown in Table 1, it has been found that a dried film and a polyimide film to be produced using the polyimide precursor solution that have been obtained in these examples have higher strength as compared to films of the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution comprising:
a polyimide precursor;
an imidazole compound;
a tertiary amine compound other than the imidazole compound; and
an aqueous solvent containing water,
wherein a ratio of the number of moles of the imidazole compound to the number of moles of a tetracarboxylic dianhydride component of the polyimide precursor is 0.5 or more and less than 1.6,
a ratio of the number of moles of the tertiary amine compound to the number of moles of the imidazole compound is within a range of 0.3 to 6.0, and
a content of the water is 50% by mass or more with respect to the aqueous solvent.

2. The polyimide precursor solution according to claim 1, wherein a ratio of the number of moles of the imidazole compound to the number of moles of the tetracarboxylic dianhydride component of the polyimide precursor is within a range of 0.5 to 1.5.

3. The polyimide precursor solution according to claim 1, wherein a boiling point of the tertiary amine compound is lower than a boiling point of the imidazole compound.

4. The polyimide precursor solution according to claim 1, wherein a difference in boiling points between the imidazole compound and the tertiary amine compound (a boiling point of the imidazole compound−a boiling point of the tertiary amine compound) is within a range of 30° C. to 150° C.

5. The polyimide precursor solution according to claim 1, wherein a boiling point of the tertiary amine compound is 150° C. or lower.

6. The polyimide precursor solution according to claim 1, wherein a boiling point of the tertiary amine compound is 60° C. or higher.

7. The polyimide precursor solution according to claim 1, wherein a content of the water is 70% by mass or more with respect to the aqueous solvent.

8. The polyimide precursor solution according to claim 1, wherein a ratio of the number of moles of the tertiary amine compound to the number of moles of the imidazole compound is 0.5 to 3.0.

9. The polyimide precursor solution according to claim 1, wherein the tertiary amine compound is at least one compound selected from the group consisting of N-substituted morpholine, trialkylamine, and tertiary amino alcohol.

10. The polyimide precursor solution according to claim 9, wherein the tertiary amine compound is N-substituted morpholine.

11. A method for producing a polyimide film, the method comprising:
applying the polyimide precursor solution according to claim 1 to a substrate to form a coating film;
drying the coating film to form a dried film; peeling the dried film from the substrate; and
baking the dried film and imidizing the polyimide precursor contained in the dried film to form a polyimide film.
